(19) United States
(12) Patent Application Publication
(10) Pub. No.: US 2021/0282588 A1
(43) Pub. Date: Sep. 16, 2021

(54) ELECTRIC GRILLING PLATE AND APPLIANCE

(71) Applicant: NuWave, LLC, Vernon Hills, IL (US)

(72) Inventors: Jung S. Moon, Long Grove, IL (US); Rong Liu, Gurnee, IL (US); Kitak Chae, Seoul (KR); Jongrok Kim, Seoul (KR)

(21) Appl. No.: 17/197,455

(22) Filed: Mar. 10, 2021

Related U.S. Application Data
(60) Provisional application No. 62/987,460, filed on Mar. 10, 2020.

(51) Int. Cl. A47J 37/06; F24C 15/32; F24C 15/16; F24C 15/08; F24C 7/08

(52) U.S. Cl. CPC A47J 37/06; F24C 15/325; F24C 7/087; F24C 15/08; F24C 15/166

(57) ABSTRACT

An electric grilling plate having a cooking surface connected to a heating element powered by an AC power source. The disclosed grilling plate is configured to be positioned in a bottom portion of a counter-top cooker, such as a convection oven, to provide direct and radiant heat to food items. Preferably, the appliance also includes an upper heating source with a fan to provide convection cooking as well.

### RELATED APPLICATION

The present application claims the filing priority of U.S. Provisional Application No. 62/987,460, titled “Electric Grilling Heat Plate and Appliance” filed on Mar. 10, 2020. The '460 application is hereby incorporated by reference.

### TECHNICAL FIELD OF INVENTION

The present application relates to an electric heating element for use in a cooking appliance. Particularly, the application relates to an electric grilling plate for a cooking appliance, as well as methods of use and systems incorporating such a grilling plate.

### BACKGROUND OF THE INVENTION

Electric cookers or ovens, commonly referred to as counter-top cookers, are well-known in the art. In comparison to a conventional oven, the counter-top cooker offers the advantage of being less bulky and, in many cases, having quicker cooking times. Typically, the counter-top cookers include a power head having an electric heating unit that generates heat in a cooking enclosure. To reduce the cooking time, counter-top cookers typically rely on circulation of a hot-air stream that is produced by a high-speed fan provided in the power head upstream of an electric heating element. Alternatively, an infrared heating element in combination with a relatively low-speed fan is used to generate sufficient heated air circulation in an oven to cook food. In either case, the heated air is produced from above a cooking surface within the cooking enclosure.

In some types of cooking such as roasting or broiling, it is desirable to expose food items to direct radiant heat to obtain even cooking and color. To achieve this result, it has been necessary in the known counter-top cookers to rotate food items periodically or continually, so that all surfaces of the food are directly exposed to the radiant heat from the heating element in the power head at the top of the cooker. This can create an issue by constantly opening the cooking enclosure to turn food items, or by the introduction of a mechanical system to continually rotate food, which may be prone to wear and failure as well as creating a significant increase in manufacturing cost.

Also, while the known counter-top cookers do cook faster than conventional ovens, the cooking time is still considered by some to be long enough that it does not create an incentive to purchase counter-top cookers. Use of direct heat to cook food items could significantly reduce cooking times to create an incentive for greater use of counter-top cookers.

These and other problems are addressed by the present device and methods to provide a system with numerous advantages in operation and effectiveness.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the disclosed electric grilling plate for a cooking appliance;

FIG. 2 is a left side view of the embodiment of the electric grilling plate shown in FIG. 1;

FIG. 3 is a top view of the embodiment of the electric grilling plate shown in FIG. 1;

FIG. 4 is a front view of the embodiment of the electric grilling plate shown in FIG. 1;

FIG. 5 is a right side view of the embodiment of the electric grilling plate shown in FIG. 1;

FIG. 6 is rear view of the embodiment of the electric grilling plate shown in FIG. 1;

FIG. 7 is a bottom view of the embodiment of the electric grilling heat plate shown in FIG. 1;

FIG. 8 is another top view of an embodiment of the disclosed grilling plate next to a standard grilling grate for a counter-top appliance; and

FIG. 9 is an exploded view of an embodiment of a counter-top cooking appliance incorporating the disclosed grilling plate/heat element as a heat source.

### DETAILED DESCRIPTION OF A PREFERRED EMBODIMENT

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

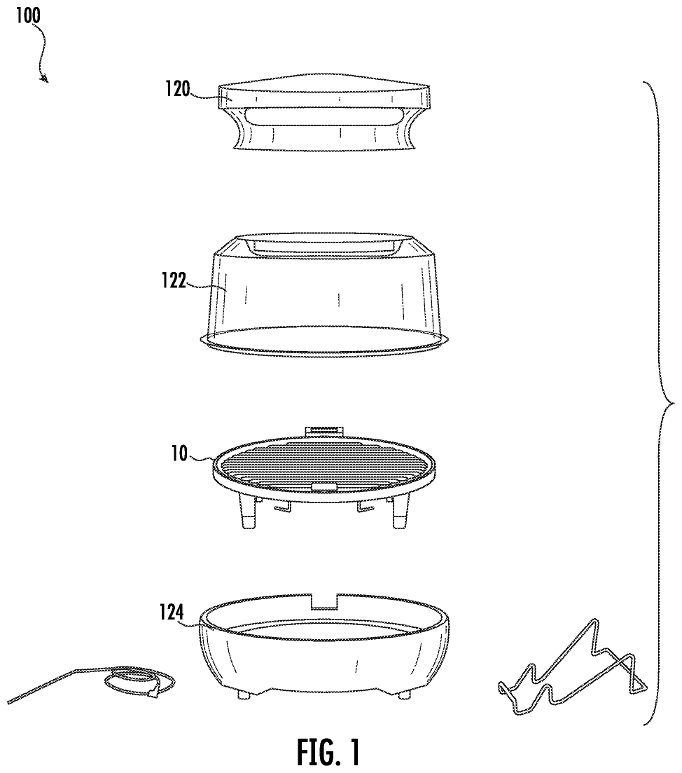

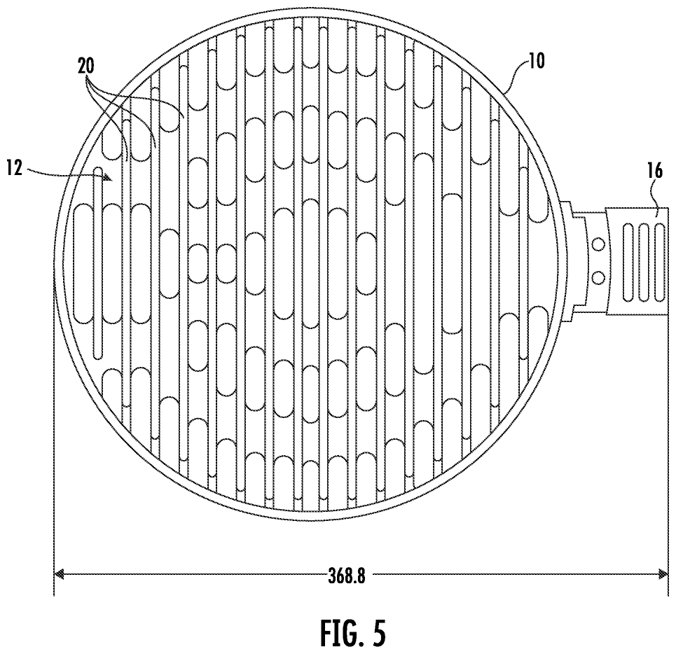

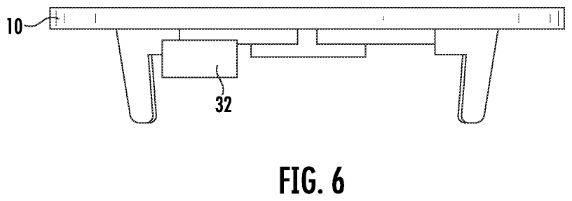

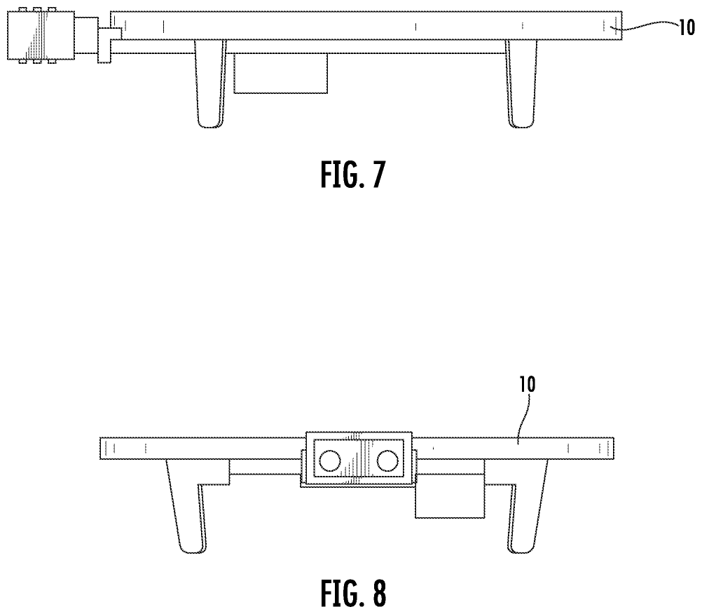

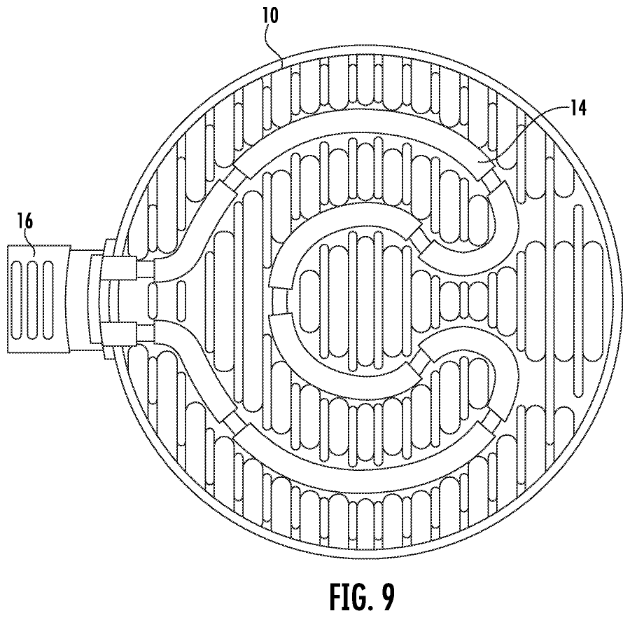

Referring now to FIGS. 1-9, there is illustrated an embodiment of a grilling plate or heat element 10 as used in an electric counter-top cooker 100. An exemplary cooker is disclosed in U.S. Pat. No. 6,917,017 to Moon et al., titled “Counter-Top Cooker Having Multiple Heating Elements” and issued on Jul. 12, 2005. The '017 patent is hereby incorporated by reference in its entirety.

FIG. 1 illustrates an embodiment of a countertop cooking appliance 100 having a power head 120, a dome 122 and a base 124. Collectively, these three components form a cooking enclosure for convection cooking. Convection cooking with a counter-top appliance is typically done through operation of the power head 120, which includes a heating element (not shown) and an air circulating fan (not shown). To facilitate the cooking process, the appliance 100 in FIG. 1 includes a non-stick electric grill plate 10 which can be positioned within the base 124 of the appliance 100. The grilling plate 10 is preferably positioned within a lower area of the cooking enclosure, thereby cooking food from below. This negates the need to turn food over to accomplish a more consistent and even cooking, as the appliance 100 cooks both from above, via the powerhead, and from below.

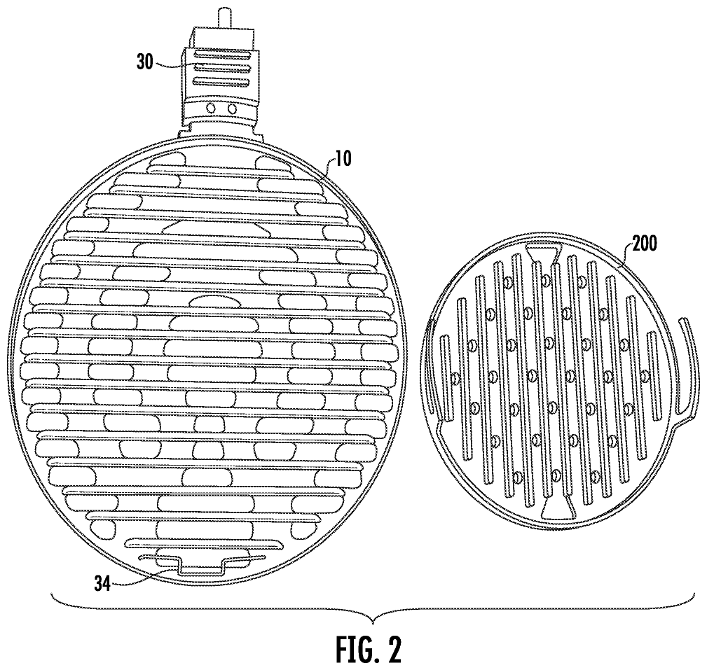

FIG. 2 is a top view of an embodiment of the disclosed grill plate 10 and a prior art cooking plate 200 used in other cooking appliances. The prior art grill plate 200 is not powered to allow heating, so it must rely on an external heat source, via convection or radiation. The present system is a significant improvement on this design.

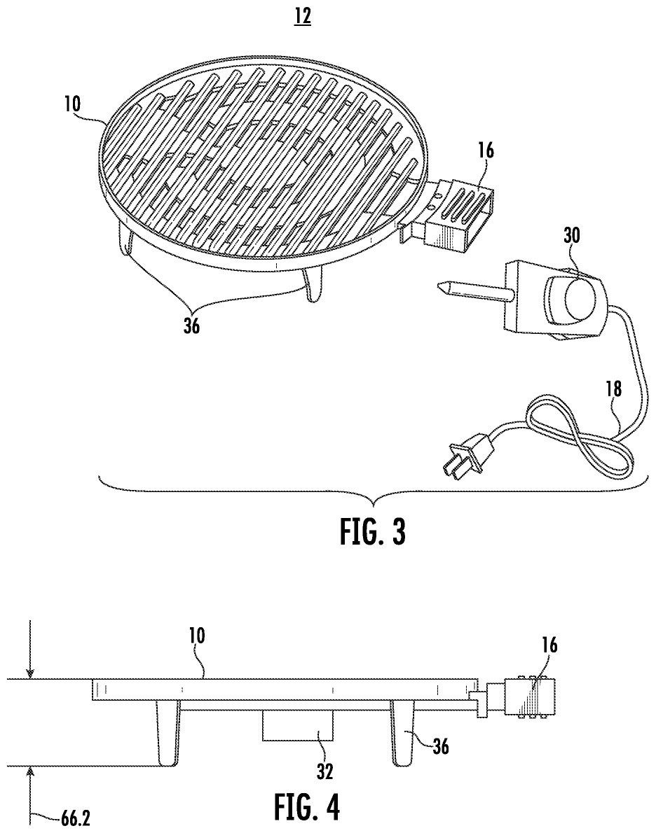

As shown in FIGS. 3-9, the grilling heat element (or plate) 10 is comprised of a grilling surface 12, a heating coil 14 positioned below and in direct contact with the grilling surface 12, an electric connector 16, and an electric cord 18 for connecting to an AC outlet. The grilling plate 10 is able to provide direct and radiant heat to food which is positioned on the grilling surface.

The grilling plate 10 is preferably circular and includes a plurality of parallel grates 20 onto which a food item would be placed. While the illustrated embodiment of the grilling plate 10 is circular, it may have most any shape which fits within the cooking enclosure of the appliance 100. The grates 20 are preferably made from a Teflon® coated heat conductive metal, cast iron or cast aluminum. Beneath in in direct contact with the grates 20 is the heating coil 14. An electrical connector 16 extends outward from the grilling plate 10 where an AC electric cord 18, including a thermostatic control 30, connects to provide power to the heating coil 14. Heat is conducted to the contacting grilling surface 12 to provide direct and radiant heat to food positioned on the grilling plate 10.

At least one opening below the heating coil 14 is provided to allow grease and other food byproducts to pass through to a removable drip pan 32. A handle 34 allows the grill plate 10 to be safely removed from the base 124 for cleaning. Legs 36 are also provided on the underside of the grilling plate 10 to keep it elevated within the cooking appliance base 124.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A counter-top cooking appliance comprising:
an electric powerhead having a heat source and a fan therein;
an enclosure for supporting the powerhead and creating a cooking space to be heated within the enclosure;
a base unit to support the enclosure; and
an electric grilling plate positioned within the cooking space below the powerhead.

2. The counter-top cooking appliance of claim 1, wherein the powerhead and grilling plate are separately powered.

3. The counter-top cooking appliance of claim 2, wherein the powerhead and grilling plate are separately controlled.

4. The counter-top cooking appliance of claim 1, wherein the electric powerhead cooks food by convection heating simultaneously to the electric grilling plate cooking by direct heating of the food.

5. The counter-top cooking appliance of claim 1, wherein the electric grilling plate comprises a food grate for supporting food items and an electric heat element in direct contact with the food grate.

6. The counter-top cooking appliance of claim 5, wherein the electric grilling plate further comprises a detachable thermostatic temperature control.

7. The counter-top cooking appliance of claim 5, wherein the electric grilling plate further comprises a plurality of legs to elevate the grilling plate within the cooking space.

8. The counter-top cooking appliance of claim 1, wherein the grilling plate is configured to provide direct heat to food during cooking.

9. An electric grilling plate for an appliance, the plate comprising:
an upper grate configured for direct contact with food items;
a heating element positioned below and in contact with the upper grate;
a power source connector attached to the heating element; and
a detachable power cord having one end configured to connect to the power source connector and another end configured for connection to an AC power source.

10. The electric grilling plate of claim 9, further comprising a thermostatic controller connected to the power source connector for controlling power to the heating element.

11. The electric grilling plate of claim 9, further comprising a plurality of legs to elevate the grilling plate above a surface.

12. The electric grilling plate of claim 9, wherein the grilling plate is configured to provide direct heat to food during cooking.

13. The electric grilling plate of claim 12, wherein the grilling plate is configured to be positioned within a convection cooking appliance.
